(19) United States
(12) Patent Application Publication
(10) Pub. No.: US 2023/0408777 A1
(43) Pub. Date: Dec. 21, 2023

(54) OPTICAL CIRCUIT BOARD AND ELECTRONIC COMPONENT MOUNTING STRUCTURE USING SAME

(71) Applicant: KYOCERA Corporation, Kyoto-shi, Kyoto (JP)

(72) Inventor: Yoshinori NAKATOMI, Nagahama-shi (JP)

(73) Assignee: KYOCERA Corporation, Kyoto-shi, Kyoto (JP)

(21) Appl. No.: 18/033,663

(22) PCT Filed: Oct. 20, 2021
(86) PCT No.: PCT/JP2021/038808

§ 371 Date: Apr. 25, 2023

(30) Foreign Application Priority Data
Oct. 28, 2020 (JP) 2020-180389

(51) Int. Cl. G02B 6/42

(52) U.S. Cl. CPC G02B 6/428; G02B 6/424; G02B 6/4238

(57) ABSTRACT

According to the present disclosure, an optical circuit board includes a wiring board and an optical waveguide. The wiring board has a first region on which a silicon photonics device is mounted, a cavity, and a second region, with the cavity interposed between the first region and the second region. The wiring board further includes a first conductor layer in the second region. The optical waveguide is located on the first conductor layer and includes a core surrounded by claddings. The first conductor layer includes a portion protruding toward the first region above the cavity.

### TECHNICAL FIELD

The present invention relates to an optical circuit board and an electronic component mounting structure using the same.

### BACKGROUND OF INVENTION

In recent years, optical fiber capable of high speed communication of large amounts of data has been used for information communication (e.g., Patent Document 1). Optical signals are transmitted and received between the optical fiber and an optical element (silicon photonics device). After mounting the optical element, underfill (sealing resin) is injected around a solder connecting portion of the optical element in order to improve the reliability of the solder connection.

However, when the underfill is injected, the underfill may flow not only around the solder connecting portion but also onto an end surface of an optical waveguide formed on an optical circuit board. When the underfill flows onto the end surface of the optical waveguide, transmission and reception of optical signals between the optical waveguide and the optical element are hindered. This increases the optical connection loss.

### CITATION LIST

### Patent Literature

Patent Document 1: JP 2015-25954 A

### SUMMARY

### Solution to Problem

According to the present disclosure, an optical circuit board includes a wiring board and an optical waveguide. The wiring board has a first region on which a silicon photonics device is mounted, a cavity, and a second region, with the cavity interposed between the first region and the second region. The wiring board further includes a first conductor layer in the second region. The optical waveguide is located on the first conductor layer and includes a core surrounded by a cladding. The first conductor layer includes a portion protruding toward the first region above the cavity.

According to the present disclosure, a method of manufacturing an optical circuit board includes forming a cavity in a wiring board using an excimer laser.

According to the present disclosure, an electronic component mounting structure includes the optical circuit board, a silicon photonics device, and an electronic component. The silicon photonics device includes a silicon waveguide and is electrically connected to the optical circuit board in the first region. The silicon waveguide faces the core of the optical waveguide.

### BRIEF DESCRIPTION OF THE DRAWINGS

FIG. 1 is a plan view illustrating an electronic component mounting structure in which a silicon photonics device and an electronic component are mounted on an optical circuit board according to an embodiment of the present disclosure.

FIG. 2A is an enlarged explanatory diagram for illustrating a cross section of a region X illustrated in FIG. 1, and FIG. 2B is a plan view of the region X illustrated in FIG. 1 (excluding an upper cladding layer of the optical waveguide).

FIG. 3 is a plan view illustrating a cavity of a wiring board and its vicinity in the optical circuit board according to the embodiment of the present disclosure.

FIG. 4A is an enlarged explanatory diagram for illustrating a region Y illustrated in FIG. 2A, and

FIG. 4B is an enlarged explanatory diagram for illustrating another embodiment in the region Y.

FIG. 5 is an electron micrograph showing part of an inner surface of the cavity formed in the optical circuit board according to the embodiment of the present disclosure.

### DESCRIPTION OF EMBODIMENTS

In the known optical circuit board, as described above, when the underfill flows onto the end surface of the optical waveguide, transmission and reception of optical signals between the optical waveguide and the optical element are hindered. This increases the optical connection loss.

Thus, there is a demand for an optical circuit board having excellent optical transmission characteristics between an optical waveguide of the optical circuit board and an optical element mounted on the optical circuit board.

In an optical circuit board according to the present disclosure, a cavity of a wiring board is located between a first region in which a silicon photonics device is mounted and a second region in which an optical waveguide is located via a first conductor layer. The first conductor layer includes a portion protruding toward the first region above the cavity. As a result, when underfill is injected, the underfill flows into the cavity, and the flow of the underfill onto the end surface of the optical waveguide located on the optical circuit board can be reduced. Thus, according to the optical circuit board of the present disclosure, excellent optical transmission characteristics are exhibited between the optical waveguide of the optical circuit board and an optical element mounted on the optical circuit board.

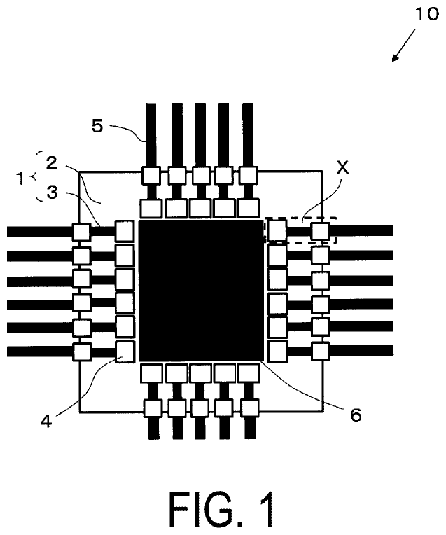

An optical circuit board according to an embodiment of the present disclosure will be described with reference to FIGS. 1 to 4. FIG. 1 is a plan view illustrating an electronic component mounting structure 10 in which a silicon photonics device 4 is mounted on an optical circuit board 1 according to the embodiment of the present disclosure.

The optical circuit board 1 according to the embodiment of the present disclosure includes a wiring board 2 and an optical waveguide 3. The wiring board 2 included in the optical circuit board 1 according to the embodiment includes a wiring board typically used in optical circuit boards.

Although not specifically illustrated, such a wiring board 2 includes, for example, a core substrate and build-up layers layered on both surfaces of the core substrate. The core substrate is not particularly limited as long as the core substrate is made of a material having an insulating property. Examples of a material having an insulating property include resins such as an epoxy resin, a bismaleimide-triazine resin, a polyimide resin, and a polyphenylene ether resin. Two or more of these resins may be mixed and used. The core substrate usually includes a through hole conductor for electrically connecting the upper and lower surfaces of the core substrate.

The core substrate may contain a reinforcing material. Examples of the reinforcing material include insulating fabric materials such as glass fiber, glass non-woven fabric, aramid non-woven fabric, aramid fiber, and polyester fiber. Two or more types of reinforcing materials may be used in combination. Inorganic filler made of, for example, silica, barium sulfate, talc, clay, glass, calcium carbonate, titanium oxide, or the like may be dispersed in the core substrate.

The build-up layers have a structure in which insulating layers and conductor layers are alternately layered. Part of the outermost conductor layer includes a first conductor layer 21a on which the optical waveguide 3 is located. The insulating layers included in the build-up layers are not limited to any particular material as long as the insulating layers have the same insulating properties as or similar insulating properties to the core substrate.

Examples of a material having an insulating property include resins such as an epoxy resin, a bismaleimide-triazine resin, a polyimide resin, and a polyphenylene ether resin. Two or more of these resins may be mixed and used. When two or more insulating layers are present in the build-up layers, the insulating layers may be made of the same resin or may be made of different resins. The insulating layers included in the build-up layers and the core substrate may be made of the same resin or may be made of different resins. Each of the build-up layers usually includes a via hole conductor for electrically connecting the layers.

Inorganic filler made of, for example, silica, barium sulfate, talc, clay, glass, calcium carbonate, or titanium oxide may be dispersed in the insulating layers included in the build-up layers.

The wiring board 2 may include solder resists on parts of both surfaces. The solder resists are made of, for example, an acryl-modified epoxy resin.

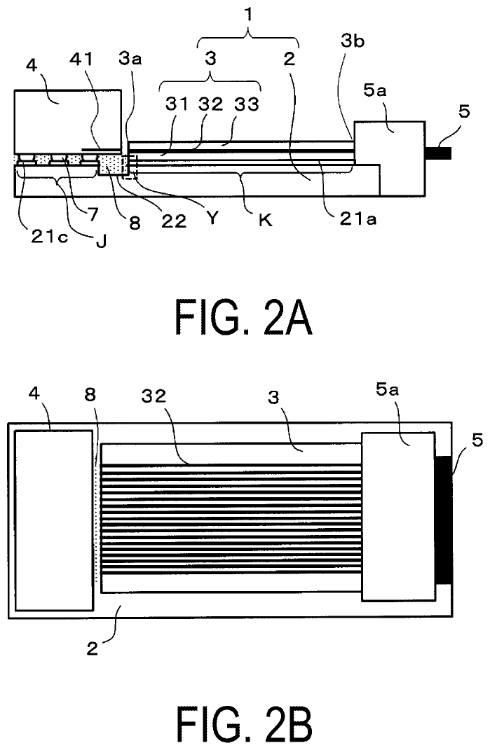

According to the embodiment, the optical waveguide 3 included in the optical circuit board 1 is disposed on a surface of the first conductor layer 21a, which is a surface of the wiring board 2. As illustrated in FIG. 2A, the optical waveguide 3 has a structure in which a lower cladding layer 31, a core 32, and an upper cladding layer 33 are layered in this order from the first conductor layer 21a side. FIG. 2A is an enlarged explanatory diagram illustrating a cross section of a region X illustrated in FIG. 1.

The lower cladding layer 31 included in the optical waveguide 3 is located on the surface of the wiring board 2, specifically on the surface of the first conductor layer 21a formed on the surface of the wiring board 2. The material forming the lower cladding layer 31 is not limited, and examples thereof include an epoxy resin and a silicone resin.

The upper cladding layer 33 included in the optical waveguide 3 is also made of the same material as or a similar material to the lower cladding layer 31. The lower cladding layer 31 and the upper cladding layer 33 may be made of the same material or may be made of different materials. The lower cladding layer 31 and the upper cladding layer 33 may have the same thickness or may have different thicknesses. For example, each of the lower cladding layer 31 and the upper cladding layer 33 has a thickness of from approximately 5 μm to approximately 150 μm.

The core 32 included in the optical waveguide 3 is a portion through which light that has entered the optical waveguide 3 propagates. The material forming the core 32 is not limited, and is set as appropriate in consideration of, for example, light transmission properties, wavelength characteristics of light propagating therethrough, and the like. Examples of the material include an epoxy resin and a silicone resin. The core 32 has a thickness of from approximately 3 μm to approximately 50 μm, for example.

As illustrated in FIG. 2B, the optical waveguide 3 includes a plurality of cores 32. FIG. 2B is a plan view of the region X illustrated in FIG. 1 (excluding the upper cladding layer of the optical waveguide).

The core 32 faces a silicon waveguide (Si waveguide) 41 included in the silicon photonics device 4 at a first end portion 3a of the optical waveguide 3 (an end portion on a side where an electronic component 6 described later is mounted). That is, a side surface of the silicon waveguide (Si waveguide) 41 faces a side surface of the core 32 of the optical waveguide 3. At the first end portion 3a, optical signals are transmitted and received between the core 32 and the Si waveguide 41.

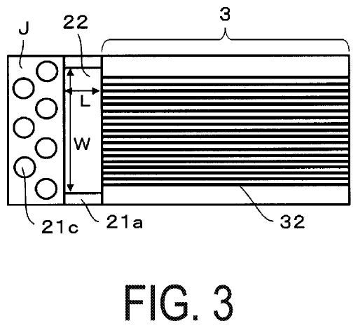

The wiring board 2 has a cavity 22 in the vicinity of the first end portion 3a of the optical waveguide 3. To be specific, the cavity 22 is located between a first region J described later in which the silicon photonics device 4 is mounted and a second region K in which the optical waveguide 3 is located with the first conductor layer 21a in between. As illustrated in FIG. 3, a width W of the cavity 22 is longer than a distance between two outermost cores 32 among the plurality of cores 32 in a plan view, and is, for example, from approximately 800 μm to approximately 5000 μm. A length L of the cavity 22 (length in a direction along which the core 32 extends) is, for example, from approximately 100 μm to approximately 1000 μm. The depth of the cavity 22 is, for example, from approximately 80 μm to approximately 300 μm.

Due to the presence of such a cavity 22, the underfill 8 flows into the cavity 22 during injection of the underfill 8 when the silicon photonics device 4 is mounted on the optical circuit board 1. As a result, the flow of the underfill 8 onto the end surface (first end portion 3a) of the optical waveguide 3 of the optical circuit board 1 can be reduced.

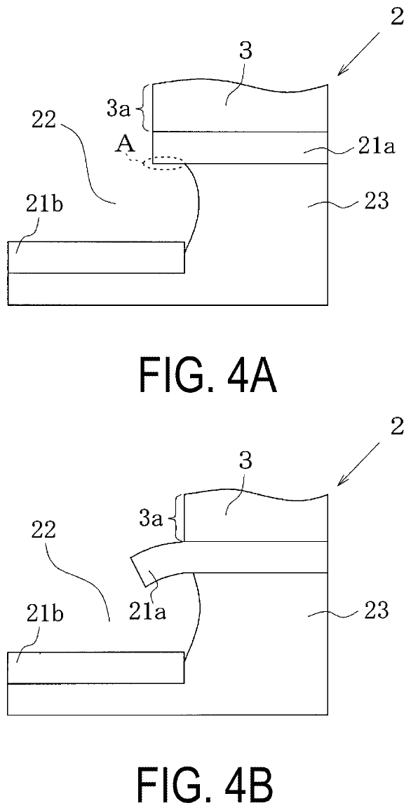

As illustrated in FIG. 4A, in the cavity 22, a sidewall surface on the optical waveguide 3 side is not flush with the end surface (first end portion 3a) of the optical waveguide 3. The sidewall surface on the optical waveguide 3 side is recessed toward a second end portion 3b opposite to the first end portion 3a with respect to the first end portion 3a. In other words, at least the first conductor layer 21a has a portion protruding toward the first region J above the cavity 22. FIG. 4A is an enlarged explanatory diagram for illustrating a region Y illustrated in FIG. 2A.

In the cavity 22, the sidewall surface on the optical waveguide 3 side is recessed toward the second end portion 3b opposite to the first end portion 3a with respect to the first end portion 3a, so that the underfill 8 flowing into the cavity 22 is less likely to overflow to the end surface (first end portion 3a) of the optical waveguide 3. To be specific, as illustrated in the part A surrounded by the dotted line in FIG. 4A, the first conductor layer 21a protrudes above the cavity 22 in an eaves-like shape, so that the eaves-like portion stops the underfill 8 from rising, thereby decreasing the likelihood of overflow. As illustrated in FIG. 4B, the first conductor layer 21a may be inclined toward a bottom portion of the cavity 22. This configuration can further reduce the rising of the underfill 8.

In the sidewall surface on the optical waveguide 3 side, the depth of the recess is not limited. For example, the deepest portion of the sidewall surface on the optical waveguide 3 side preferably is recessed toward the second end portion 3b by from approximately 5 μm to approximately 30 μm. The sidewall surface recesses with such a depth can sufficiently reduce the overflow of the underfill 8.

By providing the cavity 22, even when a reflecting mirror section is not formed in the optical waveguide 3, the optical continuity test can be relatively easily performed before mounting the electronic component. When the reflecting mirror section is formed in the optical waveguide, an optical signal for the continuity test is incident substantially perpendicularly to the surface of the optical circuit board, and the optical signal is reflected by the reflecting mirror section to perform the optical continuity test. However, when the reflecting mirror section is not formed in the optical waveguide, it is difficult to inject the optical signal for the continuity test into the core formed in the optical waveguide. That is, it is difficult to inject the optical signal for the continuity test from either a direction substantially perpendicular to the surface of the optical circuit board or a direction substantially parallel to the surface of the optical circuit board.

By providing the cavity 22, for example, part of a mirror section provided in a device for the optical continuity test can be inserted into the cavity 22. This makes it easier to align the optical signal reflected by the mirror section with the core 32 of the optical waveguide 3. As a result, the optical signal for the continuity test can be injected into the core 32 formed in the optical waveguide 3 by injecting the optical signal for the continuity test substantially perpendicularly to the surface of the optical circuit board and reflecting the optical signal by the mirror section of the device.

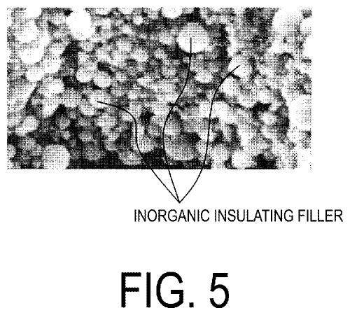

When the inorganic filler is dispersed in the insulating layer of the wiring board 2, for example, as illustrated in FIG. 5, the inorganic filler may be exposed at the inner surface of the cavity 22. FIG. 5 is an electron micrograph showing part of the inner surface of the cavity 22 formed in the optical circuit board 1 according to the embodiment. The exposure of the inorganic filler at the inner surface of the cavity 22 reduces the likelihood of the underfill 8 overflowing, the same as or similar to the protrusion of the first conductor layer 21 illustrated in FIG. 4 described above.

The amount of exposure of the inorganic filler is not limited. For example, 20 or more particles of inorganic filler having a particle size of from 0.1 μm to 1 μm are preferably exposed per 5 μm² of the inner surface of the cavity 22. When the particles of the inorganic filler are exposed at such a ratio, the effect of the exposure of the inorganic filler is exhibited more markedly. From the viewpoint of reducing the overflow of the underfill 8, the surface on which the inorganic filler is exposed is preferably the sidewall surface rather than the bottom portion of the cavity 22.

The amount of exposure as described above may be obtained, for example, by observing a secondary electron image of the inner surface of the cavity 22 taken with a scanning electron microscope and counting the number of particles of the inorganic filler using a color difference between the resin portion, which is the insulating layer, and the inorganic filler portion.

The bottom portion of the cavity 22 may be a second conductor layer 21b of the wiring board 2. By using the second conductor layer 21b as the bottom portion of the cavity 22, the depth of the cavity 22 can be easily adjusted. As illustrated in FIG. 4, the cavity 22 is located in an insulating layer 23 of the wiring board 2. By using the second conductor layer 21b as the bottom portion of the cavity 22, the cavity 22 is unlikely to be too shallow or too deep.

According to the embodiment, a method of manufacturing the optical circuit board 1 is not limited to any particular method. For example, the optical waveguide 3 is formed on the surface of the wiring board 2 obtained by a known method. The method of forming the optical waveguide 3 is also not limited, and the optical waveguide 3 can be formed by a common method.

Subsequently, a laser mask is applied to a portion other than the portion where the cavity 22 is to be formed, and the portion where the cavity 22 is to be formed is irradiated with an excimer laser. The laser mask is formed, for example, by covering the surface of the insulating layer 23 with a metal layer such as copper foil. When the inorganic filler is dispersed in the insulating layer 23 of the wiring board 2, the inorganic filler can be exposed at the inner surface of the cavity 22 by forming the cavity 22 by excimer laser irradiation. Excimer lasers have less energy than UV lasers and CO₂ lasers. Therefore, when the cavity 22 is formed using the excimer laser, the inorganic filler is less likely to be damaged by the excimer laser irradiation. As a result, only the resin portion around the inorganic filler is removed, and for example, spherical particles of the inorganic filler appear. Thus, the inorganic filler remains exposed at the inner surface of the cavity 22. Further, carbonization of the insulating layer 23 can be reduced. Thus, when the silicon photonics device 4 and the like are mounted, scattering of the carbonized portions and adhesion of the scattered carbonized portions to mounting locations can be reduced.

An electronic component mounting structure of the present disclosure will be described. According to an embodiment of the present disclosure, the electronic component mounting structure 10 has a structure in which the silicon photonics device 4 and the electronic component 6 are mounted on the optical circuit board 1 according to the embodiment. Examples of the electronic component 6 include an application specific integrated circuit (ASIC) and a driver IC.

As illustrated in FIG. 2A, the silicon photonics device 4 is electrically connected via a solder 7 to an electrode 21c of the wiring board 2 located in the first region J. In order to improve the reliability of the solder connection, the underfill 8 is filled in the vicinity of the solder connecting portion of the silicon photonics device 4. The underfill 8 is not limited as long as it is a resin that can be generally used as a sealing resin. Examples of such a resin include an epoxy resin, acrylic, siloxane, silicone, polyimide, polysilane, polynorbornene, and fluorocarbon resin.

The silicon photonics device 4 is one type of optical waveguide having, for example, a core made of silicon (Si) and a cladding made of silicon dioxide (SiO₂). The silicon photonics device 4 includes the Si waveguide 41 as described above, and further includes a passivation film, a light source unit, and a photodetection unit (not illustrated). As described above, the Si waveguide 41 faces the core 32 included in the optical waveguide 3 at the first end portion 3a of the optical waveguide 3.

For example, an electrical signal from the wiring board 2 propagates to the light source unit included in the silicon photonics device 4 via the solder 7. The light source unit emits light upon receiving the electrical signal thus propagated. The optical signal of this emitted light propagates to an optical fiber 5 connected via an optical connector 5a via the Si waveguide 41 for signal propagation and the core 32 of the optical waveguide 3.

In the optical circuit board 1 according to the embodiment, the cavity 22 of the wiring board 2 is located between the first region J and the optical waveguide 3 located on the surface of the first conductor layer 21a. Further, the first conductor layer 21a protrudes toward the first region J above the cavity 22. In other words, in the cavity 22, the sidewall surface on the optical waveguide 3 side is recessed toward the second end portion 3b opposite to the first end portion 3a with respect to the first end portion 3a. As a result, when the underfill 8 is injected, the underfill 8 flows into the cavity 22, and the flow of the underfill 8 onto the end surface (first end portion 3a) of the optical waveguide 3 of the optical circuit board 1 can be reduced. Therefore, transmission and reception of optical signals between the Si waveguide 41 and the core 32 of the optical waveguide 3 are less likely to be disturbed, and excellent optical transmission characteristics are exhibited.

### REFERENCE SIGNS

1 Optical circuit board
2 Wiring board
21a First conductor layer
21b Second conductor layer
21c Electrode
22 Cavity
23 Insulating layer
3 Optical waveguide
31 Lower cladding layer
32 Core
33 Upper cladding layer
3a First end portion
3b Second end portion
4 Silicon photonics device
41 Silicon waveguide (Si waveguide)
5 Optical fiber
5a Optical connector
6 Electronic component
7 Solder
8 Underfill
10 Electronic component mounting structure
J First region
K Second region

1. An optical circuit board comprising:
a wiring board; and
an optical waveguide, wherein
the wiring board has a first region on which a silicon photonics device is mounted, a cavity, and a second region, with the cavity interposed between the first region and the second region,
the wiring board further comprises a first conductor layer in the second region,
the optical waveguide is located on the first conductor layer and comprises a cladding and a core surrounded by the cladding, and
the first conductor layer comprises a portion protruding toward the first region above the cavity.

2. The optical circuit board according to claim 1, wherein
the wiring board comprises an insulating layer containing a plurality of particles of inorganic filler, and
the plurality of particles of the inorganic filler are exposed from an inner surface of the cavity.

3. The optical circuit board according to claim 2, wherein
20 or more of the plurality of particles of the inorganic filler having a particle size of from 0.1 μm to 1 μm per 5 μm² are exposed at the inner surface of the cavity.

4. The optical circuit board according to claim 3, wherein
the plurality of particles inorganic filler are exposed from a wall surface of the cavity.

5. The optical circuit board according to claim 1, wherein
the wiring board comprises a second conductor layer at a bottom portion of the cavity.

6. A method of manufacturing the optical circuit board according to claim 1, the method comprising:
forming a cavity in a wiring board using an excimer laser.

7. An electronic component mounting structure comprising:
the optical circuit board described in claim 1;
a silicon photonics device; and
an electronic component, wherein
the silicon photonics device comprises a silicon waveguide and is electrically connected to the optical circuit board in the first region, and
the silicon waveguide faces the core of the optical waveguide.
